(19) United States
(12) Patent Application Publication
(10) Pub. No.: US 2011/0316666 A1
(43) Pub. Date: Dec. 29, 2011

(54) INFORMATION DEVICE, COMPUTER PROGRAM PRODUCT AND METHOD THEREOF

(75) Inventor: Tatsuyoshi NOMA, Tokyo (JP)

(73) Assignee: KABUSHIKI KAISHA TOSHIBA, Tokyo (JP)

(21) Appl. No.: 13/008,738

(22) Filed: Jan. 18, 2011

(30) Foreign Application Priority Data
Jun. 25, 2010 (JP) 2010-144659

(51) Int. Cl. G06F 7/04

(52) U.S. Cl. 340/5.53

(57) ABSTRACT

According to one embodiment, an information device is provided with a display screen and a camera that face the same direction. The information device includes a determination module and an output control module. The determination module determines whether face recognition information obtained from image data of the face of a user captured by the camera matches registered face recognition information of a user to which a message is received. The output control module displays the message for the user when the face recognition information obtained from the image data matches the registered face recognition information. The output control module stacks the message when the face recognition information obtained from the image data does not match the registered face recognition information.

### CROSS-REFERENCE TO RELATED APPLICATIONS

This application is based upon and claims the benefit of priority from Japanese Patent Application No. 2010-144659, filed Jun. 25, 2010, the entire contents of which are incorporated herein by reference.

### FIELD

Embodiments described herein relate generally to an information device, and a computer product and a method thereof.

### BACKGROUND

There are various types of information devices, and those with (digital) camera, such as mobile phones with camera and personal computers (PCs) with camera, are widespread. Such an information device is capable of capturing an image using the camera as well as transmitting/receiving email or messages. Further, there has been proposed a type of information device that determines whether the user is present using the camera. For example, if the user is present, the information device notifies the user of urgent email, while if the user is absent, the information device receives a message for the user.

The conventional information device with camera can attach an image to email, but has a poor function of combining an image capturing function using the camera and a function of transmitting/receiving email and various types of messages.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external view of an information terminal with camera according to an embodiment;

FIG. 2 is an exemplary block diagram of a hardware configuration of the information terminal with camera in the embodiment;

FIG. 3 is an exemplary schematic diagram of an account-face association table in the embodiment;

FIG. 4 is an exemplary flowchart of the process of generating the account-face association table in the embodiment;

FIG. 5 is an exemplary flowchart of the operation of the information terminal with camera when receiving a message in the embodiment; and

FIG. 6 is an exemplary flowchart of the operation of the information terminal with camera when messages are stacked in the embodiment.

### DETAILED DESCRIPTION

Various embodiments will be described hereinafter with reference to the accompanying drawings. In general, according to one embodiment, an information device is provided with a display screen and a camera that face the same direction. The information device comprises a determination module and an output control module. The determination module is configured to determine whether face recognition information obtained from image data of the face of a user captured by the camera matches registered face recognition information of a user to which a message is received. The output control module is configured to display the message for the user when the face recognition information obtained from the image data matches the registered face recognition information. The output control module is configured to stack the message when the face recognition information obtained from the image data does not match the registered face recognition information.

According to another embodiment, there is provided a method applied to an information device provided with a display screen and a camera that face the same direction. The method comprises: determining whether face recognition information obtained from image data of the face of a user captured by the camera matches registered face recognition information of a user to which a message is received by a determination module; and displaying the message for the user when the face recognition information obtained from the image data matches the registered face recognition information, and stacking the message when the face recognition information obtained from the image data does not match the registered face recognition information by an output control module.

According to still another embodiment, a computer program product comprises a computer-readable storage medium having computer readable program codes embodied in the medium that, when executed, causes a computer to implement the above information device.

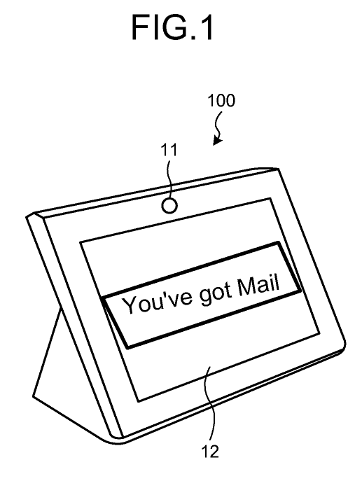

A description will be given of an information terminal with camera 100 according to an embodiment. FIG. 1 is an external view of the information terminal with camera 100 according to the embodiment.

The information terminal with camera 100 has a function of providing predetermined services as an information terminal in addition to the function of transmitting/receiving email and various types of messages. Besides, the information terminal with camera 100 comprises, as an input device, a digital camera (hereinafter, simply referred to as “camera”) 11 and a display device 12 on the front surface. The display device 12 comprises a touch panel on the front surface to detect the coordinate position of a pen or a finger and the contact area thereof. The display device 12 serves as an output device that provides display output. Various types of hardware is built in the information terminal with camera 100 as described below. In the embodiment, the camera 11 and the display screen of the display device 12 are located on the front surface of the information terminal with camera 100 to face the same direction.

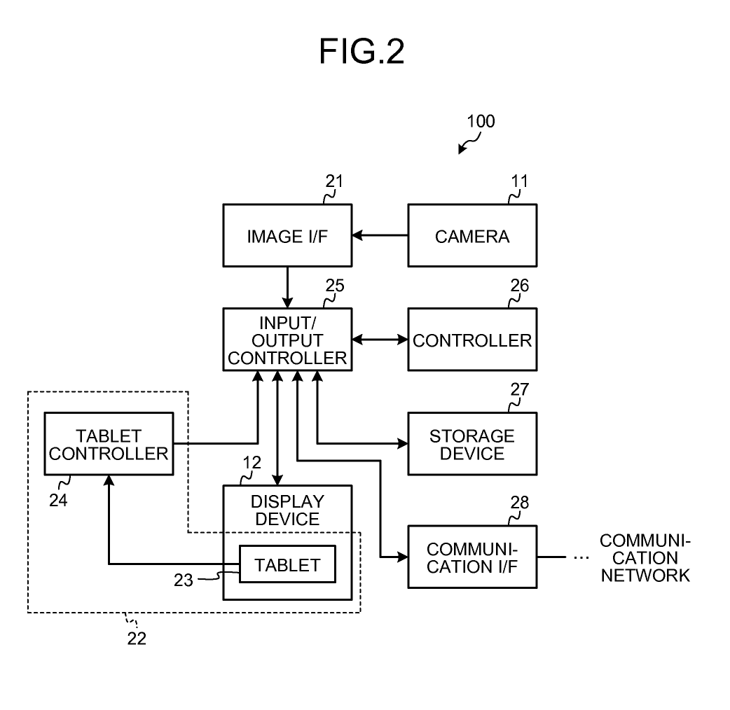

In the following, the hardware configuration of the information terminal with camera 100 will be described with reference to FIG. 2. FIG. 2 illustrates the hardware configuration of the information terminal with camera 100.

As illustrated in FIG. 2, the information terminal with camera 100 comprises the camera 11, an image interface (I/F) 21, and a controller 26. The image I/F 21 controls the camera 11 to obtain an image captured by the camera 11 and sends the image to the controller 26.

The information terminal with camera 100 further comprises a tablet input device 22 as a data input device. The tablet input device 22 comprises a tablet (touch panel) 23 and a tablet controller 24 that converts the coordinate position of a pen or a finger and the contact area thereof detected by the tablet 23 into input data.

The information terminal with camera 100 further comprises an input/output controller 25. The input/output controller 25 transfers data received from the image I/F 21 or the tablet controller 24 to a microprocessor, such as a central processing unit (CPU), of the controller 26. The input/output controller 25 also controls the output operation of the display device 12 and the input/output operation of a storage device 27 such as a hard disk drive (HDD) or a solid-state drive (SSD). The controller 26 comprises memory devices including a system memory, a basic input/output system (BIOS), a random access memory (ROM), and the like. The system memory comprises a random access memory (RAM) into which an operating system (OS) and various types of applications are loaded and which is used as a work area.

A communication I/F 28 connected to the input/output controller 25 is an interface to connect to a communication network such as a public line network, the Internet, a local area network (LAN), and the like. The information terminal with camera 100 communicates with an external switch, server, and the like through the communication I/F 28. In the embodiment, an external device (for example, a mail server, etc.) sends various types of messages to the user(s) of the information terminal with camera 100.

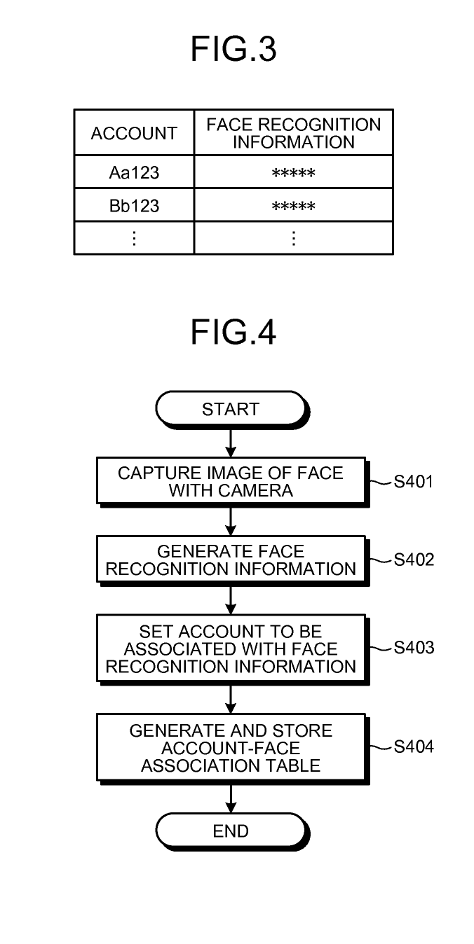

In the embodiment, an account-face association table is used to associate a user with an account of the user to receive messaging service such as email and Twitter, and information provision service to provide various types of information (for example, arrival and departure information of trains, etc.) through the cloud service or the like. More specifically, the account-face association table associates the account of the user with face recognition information of the user. FIG. 3 illustrates an example of the account-face association table. While the user account is used herein, the email address of the user or the like may also be used.

With reference to FIG. 4, a description will be given of the generation of the account-face association table in the embodiment. FIG. 4 is a flowchart of the process of generating the account-face association table.

First, a user captures an image of his/her face with the camera 11 by a predetermined operation using the tablet input device 22 (S401). The controller 26 obtains the image data of the captured user's face via the input/output controller 25.

Then, the controller 26 performs face detection and generates face recognition information (S402). The face detection may be performed using a known method. In the embodiment, the face recognition information is generated based on, for example, characteristics of a face (eyes, nose, mouth, etc.).

Next, the user sets and inputs an account of email or the like to be associated with the generated face recognition information using the tablet input device 22 (S403).

After that, the controller 26 generates an account-face association table (see FIG. 3) in which the face recognition information generated at S402 is associated with the account set and input at S403.

If there are a plurality of users, the above process is performed with respect to each of the users, and an account and corresponding face recognition information are sequentially added to the account-face association table.

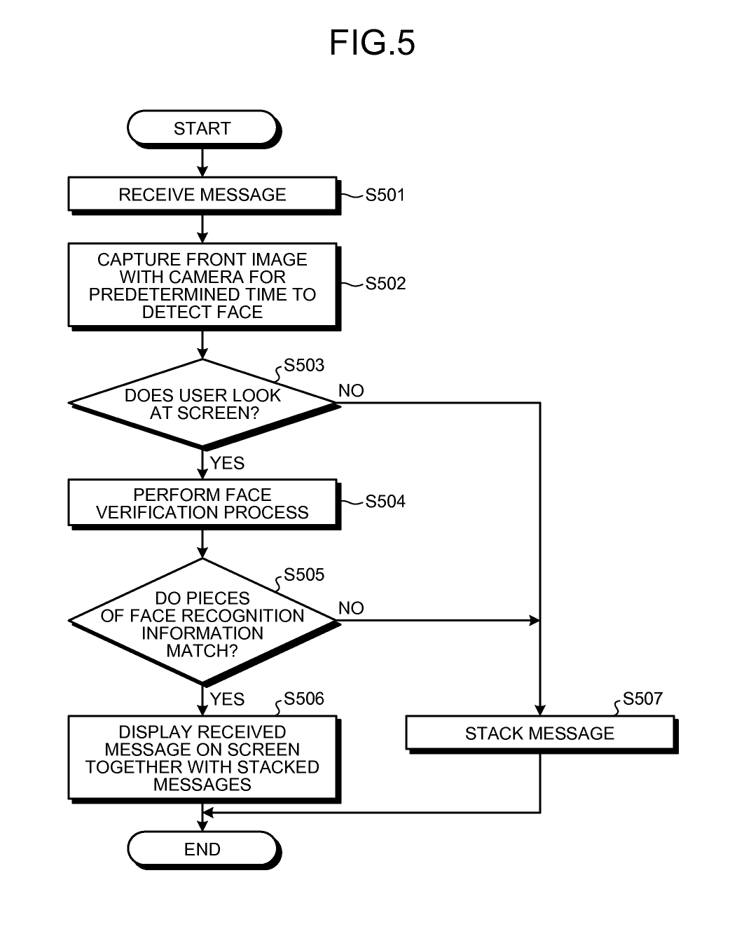

With reference to FIG. 5, a description will be given of the operation of the information terminal with camera 100 when receiving a message. FIG. 5 is a flowchart of the operation of the information terminal with camera 100 when receiving a message. The process described below is performed under the control of the controller 26.

First, the information terminal with camera 100 receives a message for a user (S501).

Then, the information terminal with camera 100 captures a front image with the camera 11 for a predetermined time to detect a face (S502).

According to the result of the face detection at S502, the information terminal with camera 100 determines whether someone looks at the screen thereof (S503). If there is no one in front of the camera 11 or, even if someone exists, he/she does not face the camera 11, i.e., when it is determined from face recognition information (for example, the positional relationship between the characteristics of his/her face such as eyes, nose, mouth, etc.) obtained as a result of the face detection that a person in front of the information terminal with camera 100 does not face the display screen and, for example, looks away, the information terminal with camera 100 determines that the user does not look at the screen. Otherwise, the information terminal with camera 100 determines that the user looks at the screen. Incidentally, the user may not be registered in the account-face association table.

Having determined that a user looks at the screen (Yes at S503), the information terminal with camera 100 performs a face verification process (S504). More specifically, the information terminal with camera 100 obtains face recognition information of the user corresponding to the message received at S501 from the account-face association table, and compares the face recognition information with that detected at S502.

As a result of the face verification process at S504, if the pieces of face recognition information match (Yes at S505), the information terminal with camera 100 displays the message received at S501 on the display screen together with one or more messages already stacked at S507 described below (S506).

On the other hand, having determined that a user does not look at the screen (No at S503), or that the pieces of face recognition information do not match (No at S505), the information terminal with camera 100 stacks the message received at S501 in the storage device 27 (S507).

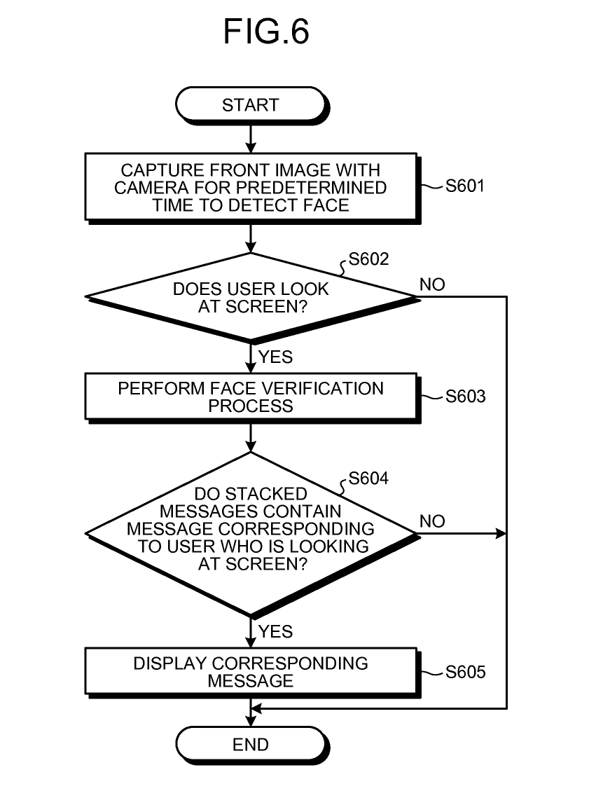

With reference to FIG. 6, a description will be given of the operation of the information terminal with camera 100 when messages are stacked. FIG. 6 is a flowchart of the operation of the information terminal with camera 100 when messages are stacked.

First, the information terminal with camera 100 captures a front image with the camera 11 for a predetermined time at predetermined timing to detect a face (S601). The predetermined timing corresponds to a time when some operation is performed on the information terminal with camera 100 or the like.

Then, according to the result of the face detection at S601, the information terminal with camera 100 determines whether someone looks at the screen thereof (S602). This determination is made in the same manner as previously described for S503 in FIG. 5.

Having determined that a user looks at the screen (Yes at S602), the information terminal with camera 100 performs a face verification process (S603). More specifically, the information terminal with camera 100 compares face recognition information detected at S601 with that registered in the account-face association table.

In response to the result of the face verification process at S603, the information terminal with camera 100 determines whether stacked messages contain a message corresponding to the user who is looking at the screen (S604). More specifically, as a result of the face verification process at S603, if face recognition information of the user who is looking at the screen is registered in the account-face association table and a message corresponding to the account of the user is stacked in the storage device 27, the information terminal with camera 100 determines that stacked messages contain a message corresponding to the user. Otherwise, the information terminal with camera 100 determines that stacked messages do not contain such a message.

Having determined that stacked messages contain a message corresponding to the user who is looking at the screen (Yes at S604), the information terminal with camera 100 displays the corresponding message on the display screen (S605).

On the other hand, having determined that a user does not look at the screen (No at S602), or that stacked messages do not contain a message corresponding to the user who is looking at the screen (No at S604), the process ends.

In the example of the operation when a message is received or messages are stacked described above, the information terminal with camera 100 displays a message corresponding to a user who is verified by the face verification process at S506 or S605. If a plurality of users are verified at the same time and they all match face recognition information registered in the account-face association table, the display screen may be divided into areas to be assigned to the users so that messages can be displayed at the same time for the users in the corresponding areas, respectively. If there are three users, for example, a father, a mother, and a daughter, messages for the father, the mother, and the daughter are displayed at the same time in predetermined areas assigned to them, respectively (for example, the display screen is divided into three areas, i.e., left, right, and center areas). Alternatively, in the order in which the users are verified, the messages may be displayed in the corresponding areas, respectively, in a time series.

Besides, using glasses (for example, liquid-crystal shutter glasses for viewing the three-dimensional television screen) having a shutter function of synchronizing with each of frames displayed on the display screen of the display device 12, messages for users may be assigned to different frames, respectively. When each messages is displayed, only the shutter of glasses, which is used by a user corresponding to a frame that is being displayed on the display device 12, may be opened so that only the user can view the message.

If a plurality of users receive the same message (or the same message is stacked for a plurality of users), the users may be verified at the same time. In this case, for example, the message is not displayed unless all the users match registered face recognition information.

As described above, according to the embodiment, when it is determined by the face detection and the face verification that the face of a user faces the information terminal with camera 100 (information device with camera) and that the user is registered, a message sent to the user can be automatically displayed. This improves the convenience for the user of the information device such as the information terminal with camera 100.

While the information terminal with camera 100 is described above as an example of the information device with camera, the information device is not limited thereto. Examples of the information device with camera include various types of information devices such as any type of personal computers, mobile phones, personal digital assistants (PDAs), and televisions, which are provided with a camera. The display device need not necessarily be built in the information device of the embodiment, and may be externally provided to the information device. In this case, the external display device performs display output.

The controller 26 that performs S502 to S504 or S601 to S603 of the process flows described above functions as a determination module in the information terminal with camera 100. The controller 26 that performs S505 to S507 or S604 to S605 functions as an output control module in the information terminal with camera 100. The controller 26 that performs the process of generating the account-face association table functions as an association module in the information terminal with camera 100.

A computer program may be executed on a computer to generate the account-face association table and to perform the process when a message is received and when messages are stacked. The computer program may be provided as being stored in a computer-readable storage medium, such as a compact disc-read only memory (CD-ROM), a flexible disk (FD), a compact disc recordable (CD-R), and a digital versatile disc (DVD), as a file in an installable or executable format. The computer program may be stored in a computer connected via a network such as the Internet so that it can be downloaded therefrom via the network.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information device comprising:
a display screen and a camera that face a same direction;
a determination module configured to determine whether face recognition information obtained from image data of a face captured by the camera matches registered face recognition information of a user who is associated with a received message; and
an output control module configured to display the message for the user based on when the face recognition information obtained from the image data matches the user's registered face recognition information, and stack the message when the face recognition information obtained from the image data does not match registered face recognition information.

2. The information device of claim 1, further comprising an association module configured to associate identification information that identifies a message for each of a plurality of users with face recognition information for recognizing each of the users, wherein
the determination module is configured to determine whether the face recognition information obtained from image data matches the registered face recognition information based on the identification information and the face recognition information associated with each other by the association module.

3. The information device of claim 1, wherein
the determination module is configured to determine whether the user faces the display screen from the image data captured by the camera, and
the output control module is configured to display the message when the user faces the display screen.

4. The information device of claim 1, wherein the message is selected from one or more stacked messages.

5. A computer program product comprising a computer-readable storage medium having computer readable program codes embodied in the medium that, when executed, causes a computer as an information device provided with a display screen and a camera that face a same direction to perform:
determining, by a determination module, whether face recognition information obtained from image data of a face captured by the camera matches registered face recognition information of a user who is associated with a received message; and
displaying, by an output control module, the message for the user when the face recognition information obtained from the image data matches the user's registered face recognition information, and stack the message when the face recognition information obtained from the image data does not match registered face recognition information.

6. A method applied to an information device provided with a display screen and a camera that face a same direction, the method comprising:
with a determination module, determining whether face recognition information obtained from image data of a face captured by the camera matches registered face recognition information of a user who is associated with a received message; and
with an output control module, displaying the message for the user when the face recognition information obtained from the image data matches the user's registered face recognition information, and stacking the message when the face recognition information obtained from the image data does not match registered face recognition information.
